(19) United States
(12) Patent Application Publication
(10) Pub. No.: US 2015/0179034 A1
(43) Pub. Date: Jun. 25, 2015

(54) Capsule Camera With Onboard Data Storage And Method For Same

(71) Applicant: OmniVision Technologies, Inc., Santa Clara, CA (US)

(72) Inventors: Junzhao Lei, San Jose, CA (US); Guannho Tsau, San Jose, CA (US)

(73) Assignee: OmniVision Technologies, Inc.

(21) Appl. No.: 14/566,338

(22) Filed: Dec. 10, 2014

Related U.S. Application Data
(60) Provisional application No. 61/919,498, filed on Dec. 20, 2013.

(51) Int. Cl. G08B 13/196; H04N 1/21; G06K 9/62

(52) U.S. Cl. CPC G08B 13/19619; G06K 9/6202; H04N 1/2104; H04N 2101/00

(57) ABSTRACT

A capsule camera with onboard data storage includes a camera capable of capturing images including an initial image frame and a next image frame. The onboard data storage is capable of storing image data associated with the images. The capsule camera also includes a volatile memory unit capable of temporarily storing the image frames, a control subsystem capable of comparing the image frames, and transmitting the next image frame to the onboard data storage if the next image frame differs from the initial image frame. A method for recording video with a capsule camera includes capturing an initial image frame using a camera, capturing a next image frame at an initial duration after capturing the initial image frame, and comparing the initial image frame and the next image frame, and optionally transmitting the next image frame to the onboard data storage.

### RELATED APPLICATIONS

This application claims benefit of priority to U.S. provisional patent application Ser. No. 61/919,498, filed Dec. 20, 2013, which is incorporated herein by reference in its entirety.

### BACKGROUND

A capsule camera is a medical device ingested by a patient. The camera capsule travels along the patient's digestive tract, and continuously takes images with an onboard image sensor/camera. The capsule continuously transmits image data wirelessly to a receiver device worn by the patient.

Prior-art capsule cameras have several shortcomings. First, they are structurally complex partly due to the presence of a wireless data transmission device. Second, they require significant battery capacity to continuously transmit wireless data. Third, the patient needs to wear the receiver device throughout the procedure, and is continuously exposed to non-ionizing radiation during the wireless data transmission.

### SUMMARY

A capsule camera with onboard data storage is disclosed. The capsule camera includes a camera capable of capturing images including an initial image frame and a next image frame. The onboard data storage is capable of storing image data associated with the images and is communicatively coupled to both a volatile memory unit and a control subsystem of the capsule camera. The volatile memory unit is capable of temporarily storing the initial image frame and the next image frame. The control subsystem is capable of determining whether the initial image frame and the next image frame are different or effectively identical. The control subsystem is also capable of transmitting the next image frame to the onboard data storage if the next image frame differs from the initial image frame.

A method for recording video with a capsule camera having onboard data storage is also disclosed. The method includes capturing an initial image frame using a camera, capturing a next image frame at an initial duration after capturing the initial image frame, comparing the initial image frame and the next image frame to determine whether they are different or effectively identical. If the next image frame differs from the initial image frame, the method also includes transmitting the next image frame to the onboard data storage.

### BRIEF DESCRIPTION OF THE FIGURES

FIG. 1 shows one capsule camera with onboard data storage, in an embodiment.

FIG. 2 shows one implementation of the capsule camera of FIG. 1 where the enclosure is opened to allow access to contacts of the onboard data storage for download of recorded image data, in an embodiment.

FIG. 3 shows one implementation of the capsule camera of FIG. 1 where electrically conductive needles penetrate the enclosure to connect with contacts of the onboard data storage for download of recorded image data, in an embodiment.

FIG. 4 shows one capsule camera with onboard data storage and wireless communication, in an embodiment.

FIG. 5 is a flowchart illustrating a method for recording video with a capsule camera having onboard data storage and an onboard camera, in an embodiment.

### DETAILED DESCRIPTION

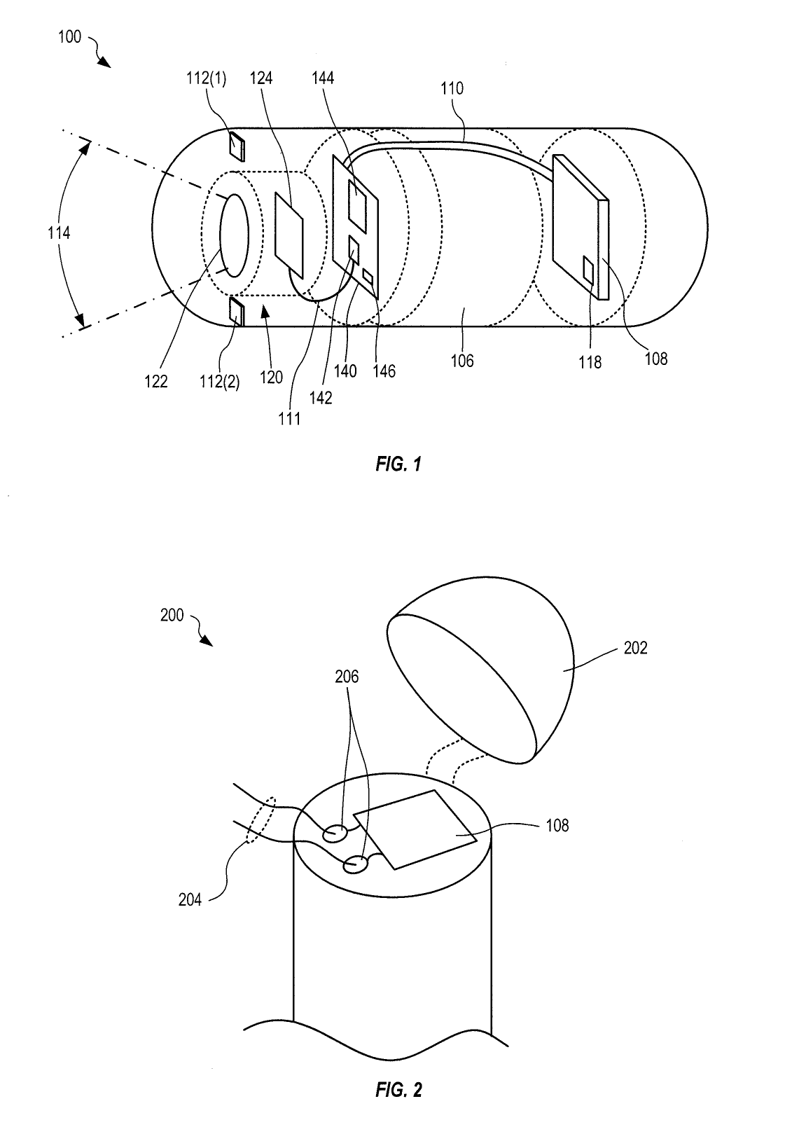

FIG. 1 shows one exemplary capsule camera 100 with a data storage unit 108 therein. Capsule camera 100 offers advantages over prior-art capsule cameras. Capsule camera 100 does not require a wireless transmitter, which means that a patient does not need to wear a receiver to capture image data captured by capsule camera 100, and that capsule camera 100 does not emit radiation while traversing the patient's body. Power consumption during operation of capsule camera 100 is reduced.

Capsule camera 100 includes a camera 120, a control subsystem 140, a battery 106, an data storage unit 108, a data write path 110 that communicatively couples data storage unit 108 with control subsystem 140, and one or more LEDs 112 that are controlled to illuminate a field of view 114 of camera 120. Camera 120 further includes a lens assembly 122 and an image sensor 124. Image sensor 124 may be a CMOS image sensor having a display resolution such as 640×480 (VGA) or 1280×720 (HD). Data storage unit 108 may include non-volatile random-access memory such as flash memory, or a different type of non-volatile memory.

Control subsystem 140 further includes a volatile memory unit 142 and an image data processor 144. Volatile memory unit 142 is coupled to the image sensor 124 by a wire connection 111. Although FIG. 1 shows two LEDs 112, capsule camera 100 may include one, three, or more LEDs 112, without departing from the scope hereof

In one example of operation, capsule camera 100 is ingested by a patient. Camera 120 captures images of the patient's digestive tract with lens assembly 122 and image sensor 124. In an embodiment, image sensor 124 captures images at frame rate, such as ten frames-per-second (FPS) or more. Image data captured by camera 120 is transmitted to control subsystem 140. For example, image data captured by image sensor 124 is directly transmitted, via wire connection 111, to volatile memory unit 142 to be temporarily stored. Volatile memory unit 142 stores two or more consecutive images to be processed by image data processor 144. When image sensor 124 transmits an image to volatile memory unit 142 to be temporarily stored, control subsystem 140 deletes the oldest image in the two or more consecutive images from volatile memory unit 142 to make room for the most recent image. Volatile memory unit 142 may have a capacity just sufficient to hold a few images, for example, from approximately 600 Kb to approximately 2 Mb, if image sensor 124 has 16-bit pixels. Image data processor 144 processes image data that is temporarily stored in volatile memory unit 142, and selects the data that needs to be more permanently stored, which control subsystem 140 then communicates via data write path 110 to data storage unit 108 for permanent storage. When capsule camera 100 is excreted by the patient, it is recovered and the stored image data is retrieved from data storage unit 108.

Image data processor 144 retrieves image data temporarily stored in volatile memory unit 142 for comparative processing. More specifically, image data processor 144 retrieves two consecutive images (for example, a first image and a second image) from volatile memory unit 142 and compares the two images pixel by pixel. In one example, image data processor 144 deems the two images as effectively identical if all pixels of the more recent image (i.e., the second image) have the same signals, at least to within typical noise-induced variation, as their corresponding pixels of the less recent image (i.e., the first image).

In another example, image data processor 144 deems two images to be effectively identical if the difference between the two, as computed by an image comparison algorithm, does not exceed a pre-determined maximum difference. The image comparison algorithm may be a two-dimensional cross-correlation, from which the maximum difference may be computed, for example as a maximum root-mean-square value of the cross-correlation values for each pixel. Other examples of image comparison algorithms include keypoint matching and scale-invariant feature transforms.

A non-volatile portion of data storage unit 108 includes machine-readable instructions 118, which are executed by image data processor 144 to implement the functionality of the image comparison algorithm.

If image data processor 144 deems the two images as not being effectively identical, image data processor 144 deems the two images as being different. If image data processor 144 deems the two consecutive images as being different, then image data processor 144 communicates the more recent, second image via data write path 110 to data storage unit 108 to be permanently stored. If image data processor 144 deems the two consecutive images as being effectively identical, then image data processor 144 does not communicate any data to data storage unit 108 for permanent storage, provided that data storage unit 108 has already stored the first image. Without departing from the scope hereof, the first image and second image may not be consecutive.

In an embodiment, if image data processor 144 deems two consecutive images effectively identical, then control subsystem 140 instructs camera 120 to reduce the initial frame rate to a slower, second frame rate. In one example of frame rate reduction, a frame-rate module 146 of control subsystem 140 instructs camera 120 to reduce an initial frame rate of ten FPS or more to a second frame rate of three FPS. In addition, image data processor 144 does not communicate any data to data storage unit 108 for permanent storage. Without departing from the scope hereof, frame-rate module 146 may be part of image data processor 144 such that image data processor 144 executes the functionality frame-rate module 146.

Switching from the initial frame rate to the slower second frame rate reduces power consumption by camera 120 and control subsystem 140, which results in extended life of battery 106. If image data processor 144 deems the two consecutive images different, then the initial frame rate is maintained, while image data processor 144 communicates the more recent image via data write path 110 to data storage unit 108 to be permanently stored. When camera 120 has a variable frame rate, control subsystem 140 may include, with each image sent to data storage unit 108, one or both of the frame rate and a timestamp associated with the image data storage. This enables proper synchronization of an output video. Image capture rates may differ from those discussed herein without departing from the scope hereof.

Capsule camera 100 may travel through the patient's digestive tract for up to approximately eight hours. It may be appreciated that, at an exemplary image capture rate of approximately ten FPS, 50% to 80% of the images may be effectively identical to their preceding images, and may thus be redundant. The comparative processing performed by image data processor 144 allows for the elimination of these redundant images from being permanently stored in data storage unit 108. Without comparative processing performed by image data processor 144, data storage unit 108 needs to be approximately 15 to 45 gigabytes to accommodate a steady image stream captured at ten FPS. With comparative processing, as discussed above, data storage unit 108 may have a capacity of approximately three to nine gigabytes. A smaller data storage unit 108 means more room can be made available to accommodate other components, such as battery 106, or a wireless RF-transmitter (not shown). As a typical capsule camera has length and diameter of approximate twenty-four millimeters and ten millimeters respectively, efficient use of space within the capsule is important.

In one example, battery 106 includes two identical sub-batteries, each with a nominal capacity of approximately 51 mA-hour (to 1.2 volts), or 220 joules. Combined, this example of battery 106 has an energy capacity of approximately 440 joules. Approximately 10% of the battery power may be devoted to the operation of LED 112, while approximately 90% of the battery power may be used to operate (a) camera 120 to capture images, (b) control subsystem 140 for comparative processing of consecutive images, and (c) data storage unit 108 for permanent image data storage. Alternatively, if there is a wireless transmission device within capsule camera 100, then approximately 45% of the battery power may be devoted to wireless data transmission.

FIG. 2 is a perspective view of a capsule camera 200, which is an embodiment of capsule camera 100 configured with an enclosure 202 that includes a removable cover. After use of capsule camera 200, enclosure 202 is opened to allow access to contacts 206 (e.g., electrical pads and/or tracks) of data storage unit 108 for download of recorded image data. In one example of operation, after capsule camera 200 exits the patient, conductors 204 are used to connect data storage unit 108 to an external data storage device (not shown) via contacts 206, wherein image data stored within data storage unit 108 is downloaded to the computer.

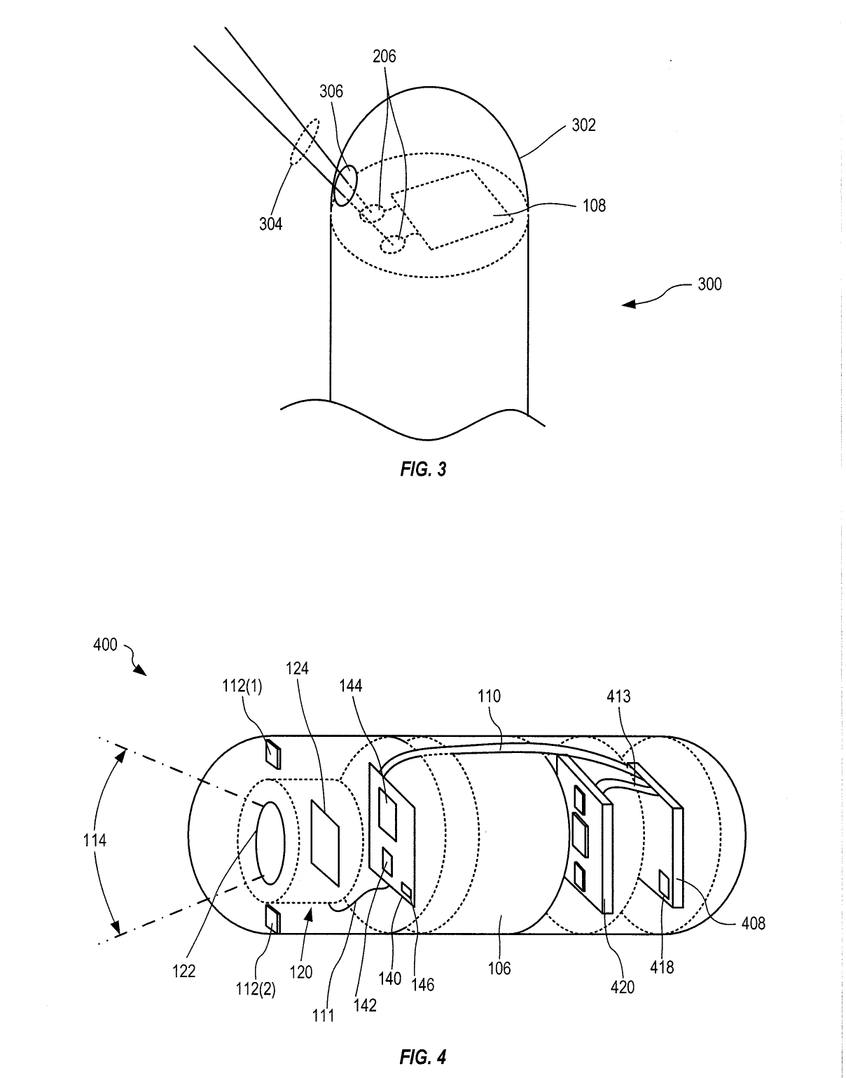

FIG. 3 is a perspective view of a capsule camera 300, which is an embodiment of capsule camera 100 configured with an enclosure 302 that includes a portion that may be punctured. After use of capsule camera 300, electrically conductive needles 304 penetrate enclosure 202 to connect with contacts 206 of data storage unit 108 for download of recorded image data. Enclosure 202 may be configured with at least one needle punch port 306. In one example of operation, after capsule camera 300 exits the patient, needle 304 containing data transmission wiring is pushed through the at least one needle punch port to establish communication (e.g., a data transmission line) between data storage unit 108 and an external data storage device (not shown). Stored image data is then transferred from data storage unit 108 to the computer.

FIG. 4 shows one exemplary capsule camera 400 with onboard data storage and wireless communication. Capsule camera 400 is similar to capsule camera 100. However, as compared to capsule camera 400, capsule camera 100 further includes a wireless RF-transmitter 420, and data storage unit 108 is replaced by a data storage unit 408. Machine-readable instructions 418 are similar to machine-readable instructions 118. Wireless RF-transmitter 420 is communicatively coupled with data storage unit 408 via a wire connection 413. Wireless RF-transmitter 420 may transmit a band-limited signal and include an antenna.

Wireless RF-transmitter 420 is capable of wirelessly and intermittently transmitting stored image data from data storage unit 408 to an outside receiver. That is, wireless RF-transmitter 420 does not operate continuously. Rather, wireless RF-transmitter 420 is switched on for wireless data transmission, and then switched off when the data transmission is complete. Wireless RF-transmitter 420 may include a timing function for switching transmission. Alternatively, wireless RF-transmitter 420 may be communicatively coupled to control subsystem 140, which sends a switching signal to wireless RF-transmitter 420 that controls whether or not wireless RF-transmitter 420 transmits. Capsule camera 400 may be configured to select data transfer periods and duration based on one or both of an algorithm and a data analysis result. For example, capsule camera 400 may be configured to transmit image data from data storage unit 408 once every 10, 20 or 30 minutes, or even longer.

Depending on the amount of data stored in data storage unit 408, the duration of data transmission may be determined accordingly. For example, data storage unit 408 may have a capacity to store at least approximately 100 to 300 megabytes (0.1 to 0.3 gigabytes) of image data, which will typically require wireless RF-transmitter 420 about one minute to transmit. After each wireless transmission, the transmitted data is deleted from data storage unit 408 to make room for the next batch of data to be stored. Capsule camera 400 may be configured to wirelessly transmit data periodically. For example, if capsule camera 400 wirelessly transmits data every half hour, it makes sixteen wireless transmissions during an eight-hour traverse time through the patient's digestive tract, wherein each wireless transmission lasts about one minute. Compared with a constant wireless mode for data transmission, an intermittent data transmission mode offers substantial energy saving since the total intermittent wireless transmission time is only a fraction (about one-thirtieth) of that of the constant wireless mode. Since image data is transmitted wirelessly, there is no need to retrieve capsule camera 400 for data recovery after it exits the patient.

Compared with data storage unit 108 of capsule camera 100, data storage unit 408 offers only a fraction of onboard data storage capacity, for example, one-thirtieth the onboard data storage capacity. Data storage unit 408 only needs to have enough capacity to hold the image data for wireless transmission every half hour. A smaller data storage unit 408 means more room can be made available to accommodate other components, such as battery 106, or wireless RF-transmitter 420.

Capsule camera 400 offers advantages over the prior art. First, it reduces non-ionizing radiation through the patient since wireless transmissions are intermittent and not continuous. Second, the power consumption of capsule camera 400 during operation is also reduced.

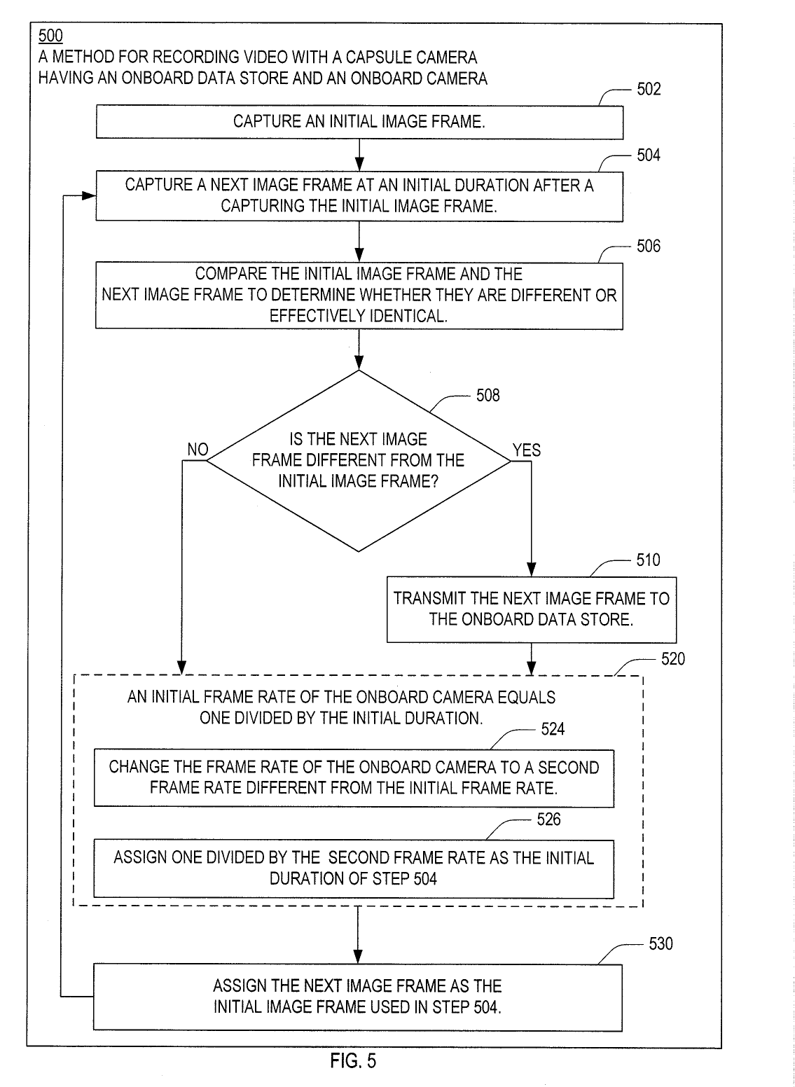

FIG. 5 is a flowchart illustrating a method 500 for recording video with a capsule camera having onboard data storage and a camera. In step 502, method 500 captures an initial image frame. In step 504, method 500 captures a next image frame at an initial duration after a capturing the initial image frame. The camera has an initial frame rate equal to one divided by the initial duration. In an example of steps 502 and 504, camera 120 of capsule camera 100 captures the initial image frame and the next image frame.

In step 506, method 500 compares the initial image frame and the next image frame to determine whether they are different or effectively identical. In an example of step 506, control subsystem 140 compares the initial image frame and the next image frame to determine whether they are different or effectively identical. More specifically, image data processor 144 within control subsystem 140 may compare the initial image frame and the next image frame to determine whether they are different or effectively identical.

Step 508 is a decision. If the next image frame differs from the initial image frame, method 500 proceeds to step 510. In step 510, method 500 transmits the next image frame to the onboard data storage. In an example of step 510, control subsystem 140 transmits the next image frame to data storage unit 108.

Step 520 is optional. If included, step 520 includes step 524 and step 526. In step 524, method 500 changes the frame rate of the camera to a second frame rate different from the initial frame rate. In an example of step 520, control subsystem 140 changes the frame rate of camera 120 according to a frame-rate algorithm included in machine-readable instructions 118, which are executed by frame-rate module 146 to change the camera's frame rate.

In a first example of step 524, step 524 follows step 508 in which the next image is effectively identical to the initial image, and control subsystem 140 decreases the frame rate of camera 120 from an initial frame rate of, for example, ten FPS to a second frame rate of, for example, three FPS.

In a second example of step 524, step 524 follows step 508 in which the next image is different from the initial image, which was identical to an image preceding it. In this case, the initial frame rate is relatively slow, three FPS for example, and control subsystem 140 increases the frame rate of camera 120 to ten FPS, for example.

In step 526, method assigns one divided by the second frame rate as the initial duration of step 504. In step 530, method 500 assigns the next image frame as the initial image frame used in step 504, and method 500 repeats starting with step 504.

If step 506 determines that more than two consecutive images are effectively identical, method 500 may skip step 520, if current frame rate (second frame rate) equals a predetermined lowest-allowable frame rate. For example, capsule cameras 100 and 400 may be configured to operate at one of two frame rates, “fast” or “slow,” respectively corresponding to whether the next image differs from, or is effectively equal to, the initial image. In a different embodiment, capsule cameras 100 and 400 may be configured to operate at one frame rate selected from more than two accessible frame rates.

### Combinations of Features

Features described above as well as those claimed below may be combined in various ways without departing from the scope hereof. For example, it will be appreciated that aspects of a capsule camera described herein may incorporate or swap features of another capsule camera described herein. Similarly, aspects of a method described herein may incorporate or swap features of another method described herein. The following examples illustrate possible, non-limiting combinations of embodiments described above. It should be clear that many other changes and modifications may be made to the methods and camera capsule cameras herein without departing from the spirit and scope of this invention.

(A1) A capsule camera with onboard data storage may include a camera capable of capturing images including an initial image frame and a next image frame, a data storage unit capable of storing image data associated with the images, a volatile memory unit communicatively coupled with the data storage unit and capable of temporarily storing the initial image frame and the next image frame, and a control subsystem communicatively coupled to the data storage unit and capable of (a) determining whether the initial image frame and the next image frame are different or effectively identical, and (b) transmitting the next image frame to the data storage unit if the next image frame differs from the initial image frame.

(A2) In the capsule camera denoted as (A1), the next image frame may consecutively follow the initial image frame.

(A3) In either or both of the capsule cameras denoted as (A1) and (A2), the control subsystem may have an image data processor that determines whether the initial image frame and the next image frame are different or effectively identical.

(A4) In any of the capsule cameras denoted as (A1) through (A3), the control subsystem may be capable of changing the frame rate of image capture by the camera according to whether the control subsystem determines the initial image frame and the next image frame to be different or effectively identical.

(A5) Any of the capsule cameras denoted as (A1) through (A4) may include at least one contact electrically coupled with the data storage unit for transferring the image data from the data storage unit to an external data storage device.

(A6) Any of the capsule cameras denoted as (A5) may include an enclosure having a removable portion for enabling access to the at least one contact.

(A7) Any of the capsule cameras denoted as (A6) may include an enclosure with at least one needle port for receiving a needle for electrically connecting to the at least one contact.

(A8) Any of the capsule cameras denoted as (A1) through (A7) may include an RF transmitter capable of wirelessly and intermittently transmitting the image data from the data storage unit to an external receiver

(A9) In any of the capsule cameras denoted as (A8), an interval between intermittent transmissions from the RF transmitter may be based on one or both of an algorithm and a data analysis result.

(B1) A method for recording video with a capsule camera having onboard data storage may include capturing an initial image frame using a camera, capturing a next image frame at an initial duration after capturing the initial image frame, comparing the initial image frame and the next image frame to determine whether they are different or effectively identical, and if the next image frame differs from the initial image frame, transmitting the next image frame to the onboard data storage.

(B2) The method denoted as (B1) may also include, when the next image frame is determined to be effectively identical to the initial image frame, changing an initial frame rate, corresponding to the initial duration, of the camera to a second frame rate different from the initial frame rate.

(B3) In the method denoted as (B2), the second frame rate may be less than the initial frame rate.

(B4) The method denoted as (B1) may also include, when the next image frame is determined to be different from the initial image frame, changing the initial frame rate, corresponding to the initial duration, of the camera to a second frame rate different from the initial frame rate.

(B5) In the method denoted as (B4), the second frame rate may be greater than the initial frame rate.

(B6) Any of the method denoted as (B1) through (B5) may further include transmitting the initial image frame to the onboard data storage.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A capsule camera with onboard data storage, comprising:
a camera capable of capturing images including an initial image frame and a next image frame;
a data storage unit capable of storing image data associated with the images;
a volatile memory unit communicatively coupled with the data storage unit and capable of temporarily storing the initial image frame and the next image frame; and
a control subsystem communicatively coupled to the data storage unit and capable of (a) determining whether the initial image frame and the next image frame are different or effectively identical, and (b) transmitting the next image frame to the data storage unit if the next image frame differs from the initial image frame.

2. The capsule camera of claim 1, the next image frame consecutively following the initial image frame.

3. The capsule camera of claim 1, the control subsystem having an image data processor that determines whether the initial image frame and the next image frame are different or effectively identical.

4. The capsule camera of claim 1, the control subsystem being capable of changing the frame rate of image capture by the camera according to whether the control subsystem determines the initial image frame and the next image frame to be different or effectively identical.

5. The capsule camera of claim 1, further comprising at least one contact electrically coupled with the data storage unit for transferring the image data from the data storage unit to an external data storage device.

6. The capsule camera of claim 5, further comprising an enclosure having a removable portion for enabling access to the at least one contact.

7. The capsule camera of claim 5, further comprising an enclosure with at least one needle port for receiving a needle for electrically connecting to the at least one contact.

8. The capsule camera of claim 1, further comprising an RF transmitter capable of wirelessly and intermittently transmitting the image data from the data storage unit to an external receiver.

9. The capsule camera of claim 8, wherein an interval between intermittent transmissions from the RF transmitter is based on one or both of an algorithm and a data analysis result.

10. A method for recording video with a capsule camera having onboard data storage comprising:
capturing an initial image frame using a camera;
capturing a next image frame at an initial duration after capturing the initial image frame;
comparing the initial image frame and the next image frame to determine whether they are different or effectively identical; and if the next image frame differs from the initial image frame,
transmitting the next image frame to the onboard data storage.

11. The method of claim 10, further comprising, when the next image frame is determined to be effectively identical to the initial image frame:
changing an initial frame rate, corresponding to the initial duration, of the camera to a second frame rate different from the initial frame rate.

12. The method of claim 11, the second frame rate being less than the initial frame rate.

13. The method of claim 10, further comprising, when the next image frame is determined to be different from the initial image frame:
changing the initial frame rate, corresponding to the initial duration, of the camera to a second frame rate different from the initial frame rate.

14. The method of claim 13, the second frame rate being greater than the first frame rate.

15. The method of claim 10, further comprising transmitting the initial image frame to the onboard data storage.
